(19) United States
(12) Patent Application Publication
(10) Pub. No.: US 2024/0157765 A1
(43) Pub. Date: May 16, 2024

(54) VEHICLE INTERIOR TRIM PART AND METHOD FOR MANUFACTURING A VEHICLE INTERIOR TRIM PART

(71) Applicant: Faurecia Innenraum Systeme GmbH, Hagenbach (DE)

(72) Inventors: Hugo Bonvalet, Strasbourg (FR); Christophe Wagner, Hagebach (DE)

(21) Appl. No.: 18/506,721

(22) Filed: Nov. 10, 2023

(30) Foreign Application Priority Data
Nov. 11, 2022 (DE) 10 2022 211 966.5

(51) Int. Cl. B60H 1/22; B29C 45/14; B60R 13/02

(52) U.S. Cl. CPC B60H 1/2227; B29C 45/14467; B60R 13/02; B29L 2031/3041; B60R 2013/0287

(57) ABSTRACT

The application relates to a vehicle interior trim part (1) and a method for manufacturing a vehicle interior trim part (1). The proposed vehicle interior trim part (1) comprises a carrier (12) which has polymeric material and an electrical or optical device (2). The vehicle interior trim part (1) also comprises a connection element (3) arranged on a rear side (16) of the carrier (12) for connecting the electrical or optical device (2) and at least one conductor (4) which connects the electrical or optical device (2) to the connection element (3). The connection element (3) has a plug receptacle (6) which is configured to produce an electrically or optically conductive connection of a plug to the conductor (4). In addition, the connection element (3) has a recess (10) within which the conductor (4) is accommodated. The recess (10) is at least partially filled by the polymeric material of the carrier (12) in such a way that the conductor (4) is at least partially surrounded by the polymeric material of the carrier (12).

### CROSS REFERENCE TO RELATED APPLICATIONS

This application claims priority to German Application No. DE 10 2022 211 966.5, filed Nov. 11, 2022, which is incorporated herein in its entirety.

### TECHNICAL FIELD

The application relates to a vehicle interior trim part and a method for manufacturing a vehicle interior trim part.

### BACKGROUND

Vehicle interior trim parts which comprise electrical or optical devices are known from the prior art. For example, heating mats can be integrated into a vehicle interior trim part and enable a heating or de-icing function of the vehicle interior trim part. Light-emitting devices are also possible, which devices are integrated, for example, in the form of optical fibers or LEDs into the vehicle interior trim part and enable illumination, for example a decorative illumination. In the manufacture of vehicle interior trim parts, injection molding processes are frequently used, for example in order to form a flat carrier. It is conceivable that the electrical or optical device is inserted into the carrier and fastened thereto. In this case, the provision of a connection element, designed, for example, integrally with the device is generally necessary in order to connect the device to the vehicle electronics. In this case, additional manufacturing steps can be carried out with which, for example, a connecting plug is subsequently soldered to a heating mat. Such connection elements can have insufficient stability and do not adequately protect electrical components or lead to undesired vibration noises during operation of the vehicle.

### SUMMARY

Against this background, it is an object of the present application to propose an improved vehicle interior trim part. In particular, it is an object of the present application to propose a vehicle interior trim part which is stable and durable and can be manufactured comparatively easily. Furthermore, it is an object of the present application to propose a correspondingly advantageous method for manufacturing a vehicle interior trim part.

These objects are achieved by a vehicle interior trim part having the features of claim 1 and by a method having the features of another claim. Advantageous developments result from the features of the dependent claims and of the exemplary embodiments.

The proposed vehicle interior trim part comprises a carrier having a polymeric material and an electrical or optical device. The electrical or optical device is generally accommodated on or in the carrier. The vehicle interior trim part also comprises a connection element arranged on a rear side of the carrier for connecting the electrical or optical device and at least one conductor which connects the electrical or optical device to the connection element. The conductor can be an electrical conductor, whereby the electrical or optical device can be supplied with current, for example. The conductor can also be an optical conductor, in particular an optical fiber, whereby the device can be supplied with light, for example. The conductor can also be an optical fiber which can serve for data transmission. The connection element has a plug receptacle which is configured to produce an electrically or optically conductive connection of a plug to the conductor. In addition, the connection element has a recess, for example a cavity, in which the conductor is accommodated. The recess is filled at least in regions, in particular completely, by the polymeric material of the carrier in such a way that the conductor is at least partially surrounded, for example overmolded, by the polymeric material of the carrier, in particular completely surrounding a conductor circumference.

Given that the connection element has a recess in which the conductor is at least partially surrounded by the polymeric material of the carrier, it is achieved that the conductor is sealed and insulated in a particularly simple manner. As a result, on the one hand, the manufacture and assembly of the vehicle interior trim part are simplified in that within the recess the polymeric material of the carrier fills the recess. This can take place, for example, in one method step together with the manufacture of the carrier. On the other hand, the stability and longevity of the vehicle interior trim part are increased. In this case, the proposed vehicle interior trim part can counteract, for example, corrosion of the conductor, by at least partial sealing against moisture and other environmental influences, and undesired noise development due to vibrations. In addition, a reliable electrical insulation of the conductor can be achieved by the proposed vehicle interior trim part.

The vehicle interior trim part can be, for example, a door panel, a headliner, a pillar cover, a center console or an instrument panel. The vehicle interior trim part generally has a visible side facing the vehicle interior and an opposite rear side facing away from the vehicle interior. The connection element is generally arranged on the rear side of the vehicle interior trim part and can form a part of the rear side of the vehicle interior trim part. A front side of the carrier is generally facing the vehicle interior. The front side of the carrier can form the visible side, but the vehicle interior trim part has at least one further layer, in particular a decorative layer, which forms the visible side of the vehicle interior trim part. The electrical or optical device is typically arranged between the visible side and the rear side of the vehicle interior trim part or on the rear side of the vehicle interior trim part.

A method for manufacturing a vehicle interior trim part is accordingly advantageous. With this method, an electrical or optical device is provided. A conductor is provided beforehand, simultaneously or subsequently. A connection element for connecting the electrical or optical device is provided beforehand, simultaneously or subsequently, wherein the connection element has a plug receptacle which is configured to produce an electrically or optically conductive connection of a plug to the conductor, wherein the conductor connects the electrical or optical device to the connection element and wherein the connection element has a recess in which the conductor is accommodated. In a further method step, a carrier is manufactured by injection molding with a polymeric material such that the connection element is arranged on a rear side of the carrier, and the recess is at least partially filled by the polymeric material of the carrier in such a way that the conductor is at least partially surrounded by the polymeric material of the carrier. The manufactured vehicle interior trim part can have any of the features described above or below with respect to the vehicle interior trim part. In the method, the connection element is, as a rule, at least partially overmolded and/or back-injected with the polymeric material of the carrier, in particular in the method step with the manufacture of the carrier.

In typical embodiments, the device is an electrical heating element. In particular, the device can be a heating mat. The heating mat usually comprises one or more resistance wires. The heating mat can be configured to provide a heating function of the vehicle interior trim part so that the vehicle interior and in particular a vehicle occupant is heated. It can additionally or alternatively be provided that the device is an optical, in particular optoelectronic, device. For example, the device can be configured to provide a functional or decorative interior lighting. Additionally or alternatively, the device can be a sensor device and/or an operating device. The device is generally arranged next to and in particular spaced apart from the connection element when viewing toward the rear side of the vehicle interior trim part. A region of the carrier in which the connection element is arranged is generally spaced apart from a region of the carrier in which the device is arranged, for example at a distance of at least 5 cm. In some embodiments, the device can be embedded in the polymeric material of the carrier. It can additionally or alternatively be provided that the polymeric material of the carrier is integrally molded onto the device. This can take place in the method step of manufacturing the carrier. In addition, in some embodiments the device can be overmolded with the polymeric material of the carrier. For example, the device can be connected to the carrier, in particular to the polymeric material of the carrier, in an integral and/or positive-locking manner. The electrical or optical device can have holes, depressions or projections for positive-locking connection and/or for improved cohesive connection to the carrier. It can be provided that the polymeric material of the carrier rests directly in contact with the device.

In typical embodiments, the connection element has a base element. The base element can have a front side and a rear side. The front side of the base element can at least partially rest against the rear side of the carrier. In particular, the front side of the base element can rest against the polymeric material of the carrier. The rear side of the base element can limit the recess. It can be provided that the rear side of the base element forms a front boundary of the recess. By providing a base element, a reliable connection between the carrier and the connection element and simultaneously a reliable delimitation of the recess can generally be ensured. Typically, at least one region of the base element is arranged between the carrier and the polymeric material of the carrier, which material at least partially fills the recess, as a result of which an improved connection is produced in a simple manner, which connection is at least partially positive-locking in some embodiments between the connection element and the carrier. The base element is generally substantially flat and/or shell-shaped. The base element can be arranged substantially parallel to the carrier and in particular rest against it in a planar manner. The front side of the base element is generally substantially planar in order to ensure a reliable resting against the carrier. The rear side of the base element is generally partially planar. The rear side is generally oriented in substantial regions of the rear side parallel to the front side. The base element generally has side surfaces. The side surfaces can extend away from the carrier at an angle. In particular, two opposing side surfaces can be inclined, in particular converging in the direction of the carrier. The base element can be a substantially plate-shaped element. In particular, the base element can be a substantially rectangular plate-shaped element.

In most embodiments, the connection element has a cover element. The cover element can be arranged on the base element. For example, the cover element can be placed in contact with the base element. The cover element generally delimits the recess, in particular at least partially. Typically, the cover element together with the base element defines the recess. The cover element can form a rear boundary of the recess. By providing the cover element, a protection of the conductor can be further improved. In addition, the provision of the cover element simplifies the method in that a well-controlled flow of the polymer material of the carrier is achieved. As a result, in turn, an undesired effect of a flow of the polymeric material to the conductor arranged in the recess can be reduced or avoided. It can be provided in some embodiments that the connection element has the base element and the cover element. The cavity can be formed between the cover element and the base element. The cavity can form the recess, in particular at least in some regions or completely.

In some embodiments, the base element is shell-shaped. In this case, it can be provided that the base element is oriented such that one shell base faces the carrier and one shell opening faces away from the carrier. The rear side of the base element can comprise an edge. For example, it can be provided that the base element is designed to be at least partially shell-shaped, wherein the cover element is inserted into the base element. The base element and the cover element can have shapes corresponding to one another. It can be provided that the cover element can be suitably inserted into the base element, in particular in a rotationally fixed manner. It can be provided that lateral outer surfaces of the cover element rest against inner surfaces of the base element. In this case, the cover element can be completely bordered laterally by the edge of the base element, in particular the cover element.

The carrier is generally an injection-molded part. Moreover, in most embodiments the carrier is in one piece. The polymeric material of the carrier can consist entirely of a polymer. However, it can also be provided that the polymeric material comprises, in addition to a polymer, non-polymeric constituents, for example natural materials, in particular natural fibers. The carrier can comprise a fiber mat and/or a non-woven fabric. The polymeric material of the carrier is or comprises, for example, PP or PC/ABS. The polymeric material of the carrier is typically a specific material present in all areas of the carrier. For example, the entire carrier can be homogeneous in terms of its material. It can be provided that a region of the carrier in which the device is arranged and/or a region of the rear side of the carrier on which the connection element is arranged and/or the polymeric material in the recess of the connection element are formed homogeneously and/or integrally with one another. The carrier can be manufactured in most embodiments in a single injection-molding process. The base element and/or the cover element can comprise a plastic or consist of a plastic, for example selected from the group of the polymers polypropylene, polymethyl methacrylate, polycarbonate, polystyrene and acrylonitrile butadiene styrene and can be, for example, an injection-molded part.

The conductor is generally electrically or optically conductive and generally produces an electrically or optically conductive connection between the connection element or the plug and the electrical or optical device. In typical embodiments, the conductor comprises at least one cable. The cable can electrically or optically conductively connect the connection element to the device. The cable is generally arranged immovably on and/or in the carrier. In addition, the conductor can comprise at least one connector pin. The connector pin is generally electrically or optically conductive and can be manufactured, for example, from a metal. The connector pin can be accommodated within the connection element. In some embodiments, the connector pin and the cable are connected to one another within the recess of the connection element via a connection point. The connection point is generally a solder connection, but can also be a plug-in connection. Due to the fact that the connection point according to this embodiment is arranged in the recess, an electrical connection between the cable and the connector pin can be produced in a simple manner during manufacture, for example by soldering. Subsequently, the connection point can be sealed and protected in the manner described by the introduction or presence of the polymeric material of the carrier into the recess, as a result of which a particularly robust embodiment is provided.

The connector pin can be partially accommodated within the plug receptacle for producing the electrically or optically conductive connection to the plug. Thus, the connector pin can be connected to the motor vehicle electronics. The connector pin can be arranged partially in and/or on the cover element. In an exemplary embodiment, the connector pin is accommodated completely within the connection element and/or encloses the connection element. In another exemplary embodiment, a part of the connector pin can be arranged exposed on the connection element. For a connection to the plug, the connector pin can project away from the carrier at least partially in one direction. Preferably, the connector pin projects substantially perpendicularly from the carrier or from the cover element. The connector pin can extend in part laterally with respect to the carrier. The connector pin can extend from an end accommodated within the guide element further below at an angle toward the connection point. The connection point is typically arranged in the part of the connector pin extending laterally with respect to the carrier. The connector pin can thus comprise a part which projects from the carrier or from the cover element, and a part which extends laterally with respect to the carrier or to the cover element, wherein both parts can be formed in one piece with one another. Such an embodiment allows good anchoring of the connector pin in the cover element and a reliable connection to the plug and to the electrical or optical device. For embodiments with which the conductor is optically conductive and produces a light-conducting connection between the connection element or the plug and the device, the person skilled in the art knows how the above-described electrical connections have to be changed accordingly. Preferably, glass fibers or PMMA fibers are used for optically conductive conductors. The term cable includes both electrical wires and optical fibers.

In some embodiments, the connection element, in particular the base element, has support elements. In typical embodiments, the support elements are arranged within the recess. The support elements can be surrounded on both sides by the polymeric material of the carrier. In addition, the connector pin can rest against the support elements. The connector pin can be supported by the support elements, for example by arranging the connector pin between the support elements. In this case, the support elements can support the connector pin in the lateral direction, for example. In this way, it can be ensured that the connector pin is not pushed into the recess by the flow of the polymeric material. The support elements can be arranged on the rear side of the base element.

In an exemplary embodiment, a plurality of connector pins are provided. In particular, at least two, for example four, connector pins can be provided. Each of the plurality of connector pins may have any of the features described above or in relation to the connector pin. In one embodiment having a plurality of connector pins, these connector pins can extend parallel to one another. In addition, a plurality of cables is generally provided. A number of the cables generally corresponds to a number of the connector pins. The number of cables can be at least two, for example four. Each of the plurality of cables may have any of the features described above or with respect to the cable. The plurality of connector pins and the plurality of cables are generally connected to one another in pairs at an associated connection point. In this way, each pair of one of the connector pins and one of the cables can form an associated connection point, for example a solder joint. The different pairs of one of the connector pins and one of the cables are generally electrically insulated from one another. The multiple connection points formed in this way are generally arranged within the recess of the connection element, i.e., within the same recess. In this way, it can be provided that the plurality of connection points in the recess are embedded together into the polymeric material of the carrier. It can thus be achieved that the method is further simplified by virtue of the fact that in the method step of manufacturing the carrier a plurality of connecting points is embedded in the same way into the polymeric material of the carrier to increase the robustness of the connection element. In this case, the polymeric material of the carrier can also be arranged between the connection points. In this way, the electrical insulation of the different pairs or connection points from one another can also be ensured or improved in a simple manner by the proposed vehicle interior trim part or by the method.

It can be provided that the connection element has an opening which connects the recess to the carrier. The opening makes it possible for the polymeric material of the carrier to flow into the recess of the connection element in a reliable manner. The opening can be a completely surrounded hole. The opening can form a narrow point with respect to the recess and an exterior of the connection element. An extension of the polymeric material of the carrier in the recess is generally greater in any direction in space than a maximum diameter of the opening. Consequently, a reliable inflow of the polymer material of the carrier into the recess with simultaneously good sealing of the recess can be achieved by the opening in conjunction with the connection element, in particular with the optionally provided base element and/or connection element. During manufacture, the polymeric material of the carrier generally penetrates through the opening. For the vehicle interior trim part, polymeric material of the carrier is generally arranged in the region of the opening. The opening is generally arranged on a front side of the connection element and/or in the region of a front edge of the connection element. In some embodiments, the opening is at least partially delimited by the base element. In typical embodiments, the opening is at least partially delimited both by the base element and by the cover element. In this way, a first section of a circumference of the opening can be formed by the base element. In addition, a second section of the circumference of the opening can be formed by the cover element. The first and second sections can completely surround the opening, so that the opening is delimited completely and only by the cover element and the base element. The opening can be arranged at a joining line between the base element and the cover element.

It can be provided that the conductor runs through the opening. In particular, it can be provided that the cable runs through the opening. In this way, it can be achieved that the same opening is used for the passage of the conductor and for the passage of the polymeric material of the carrier. Thus, a structurally simplified connection element and a simplified method are thus made possible. In addition, the part of the conductor running through the opening can hereby also be embedded in the polymeric material, whereby damage, in particular cable breakage, can be prevented. A size of the opening, i.e., a maximum diameter of the opening, generally corresponds to at least 1.5 times and/or at most 10 times a diameter of the conductor in this region. In this way, a reliable flow of the polymeric material of the carrier into the recess and a reliable fixing of the cable can be ensured. In typical embodiments, a plurality of openings is provided, wherein the number of openings generally corresponds in any case to a number of conductors or cables. The number of openings can be at least two, for example four.

It can be provided that the connection element has at least one rib for conducting a flow of the polymeric material of the carrier into the recess and/or within the recess. By such a rib, the flow of the polymeric material of the carrier can be controlled and improved. In particular, it can be achieved by the rib that the flow of the polymeric material of the carrier does not lead to displacements of the conductor within the recess or does so to a reduced extent. In particular, the connection point that may be provided can be protected in this way. In typical embodiments, the rib runs parallel to the connector pin. If a plurality of connector pins is provided, the rib can be at least partially arranged between two adjacent connector pins. The rib can project into the recess of the connection element. The rib can extend away from a rear side of the base element and/or extend away from a front side of the cover element. The rib can be formed integrally with the base element or integrally with the cover element. In typical embodiments, a plurality of ribs, in particular at least two, for example three ribs, are provided. Each of these ribs can have any of the features described above or below with respect to the rib. The plurality of ribs can run parallel to one another, in particular parallel to the connector pin or connector pins. The plurality of ribs can each be at least partially arranged between adjacent connector pins.

The plug receptacle can have a guide element for the plug. The guide element can define, for example, a cavity for accommodating the plug and can be, for example, a substantially tubular element. The guide element can comprise a circumferential wall. One end of the connector pin can be accommodated within the guide element. The guide element can provide a positive-locking, in particular in a rotationally fixed manner, receptacle for a plug into which the plug can be inserted. In this way, the plug can come to rest in a defined orientation within the plug receptacle via the guide element in order to produce a conductive connection to the connector pin. If a plurality of connector pins is provided, they are generally each partially accommodated and spaced apart from one another within the guide element. An opening for accommodating the plug is generally provided on an end of the guide element opposite the cover element. In addition, the guide element can comprise at least one latching element which is configured to secure a plug accommodated within the guide element. A section of the guide element opposite the cover element is generally free-standing. The base element or the cover element can be formed integrally with the guide element. In some embodiments, the guide element extends away from a rear side of the base element and/or of the cover element, in particular perpendicularly. In particular, the base element or the cover element can be formed with the guide element as a one-piece injection-molded part. The guide element is generally perpendicular to the rear side of the carrier. In typical embodiments, the plug can be inserted substantially in the direction of a surface normal of the carrier into the plug receptacle of the connection element.

In some embodiments, the carrier has holding sections, in particular holding clamps. The holding sections can be rib-shaped. The holding sections are generally formed from the polymeric material of the carrier. The holding sections typically extend away from the rear side of the carrier. In typical embodiments, the holding sections surround the connection element. In particular, the holding sections can surround a lateral outer edge of the connection element. It can be provided that the holding sections connect the carrier to the connection element at least partially in a positive-locking manner. It is additionally or alternatively possible to provide a material bond between the holding sections and the connection element. The holding sections can be designed to be fully L-shaped or at least partially L-shaped to surround the connection element.

Features mentioned above or below with respect to the vehicle interior trim part apply accordingly to the method for manufacturing a vehicle interior trim part and vice versa.

### BRIEF DESCRIPTION OF THE DRAWINGS

Exemplary embodiments are described below using figures. In the figures:

FIGS. 1(a) and (b) show schematic views when manufacturing a vehicle interior trim part,

FIG. 2 shows a perspective partial view of the vehicle interior trim part,

FIGS. 3(a) and (b) show partial sectional views of the vehicle interior trim part,

FIGS. 4(a) and (b) show perspective views of connector pins and their position within a connection element of the vehicle interior panel, and

FIGS. 5(a) to (c) show perspective views of a base element and of a cover element of the connection element.

### DETAILED DESCRIPTION

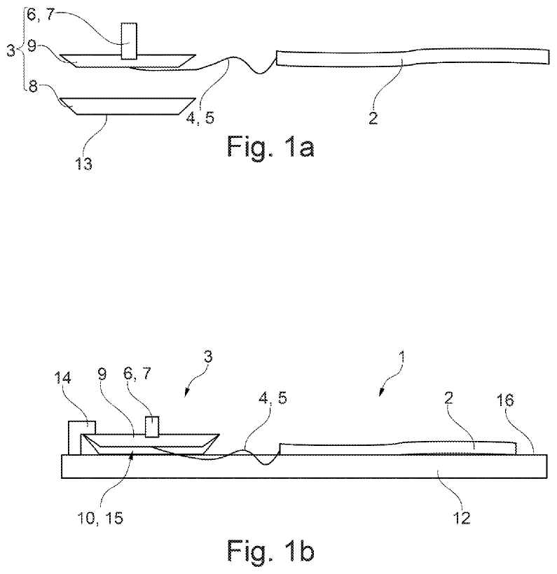

FIGS. 1(a) and (b) illustrate steps in the manufacture of a vehicle interior trim part 1, which comprises an integrated electrical or optical device 2. In the example shown, the device 2 is a heating mat which provides a heating function of the vehicle interior trim part 1. In the manufacture of the vehicle interior trim part 1, a connection element 3 and a conductor 4 are provided next to the heating mat 2 in order to electrically connect the heating mat 2 to the vehicle electronics. In this case, the conductors 4, which generally each have a cable 5, establish an electrical connection between the heating mat 2 and a plug receptacle 6 of the connection element 3. The plug receptacle 6 of the connection element 3 has a substantially tubular guide element 7 into which a plug (not shown) for establishing the connection to the vehicle electronics (in the illustration from above) can be inserted. The connection element 3 also has a cover element 9 which, in the example shown, is connected to the guide element 7 and can be designed, for example, as a one-piece injection-molded part. Furthermore, the connection element 3 has a base element 8, which is generally likewise formed by an injection-molded part. The cover element 9 is placed on the base element 8 (see FIG. 1(b)). In this case, a recess 10 of the connection element 3 shown in the following figures is formed in the form of a cavity between the base element 8 and the cover element 9. The conductors 4 run through the recess 10 of the connection element 3, wherein solder joints are provided within the recess 10, which solder joints connect each of the cables 5 to one of a plurality of connector pins 11 shown further below. As a rule, the cables 5 are soldered to the connector pins 11 before the carrier is manufactured, in particular before the cover element 9 has been arranged on the base element 8. FIG. 1(b) illustrates the vehicle interior trim part 1 after a polymeric material of a carrier 12 has been integrally molded onto the above-described components by means of injection molding. In particular, it can be provided that the heating mat 2 is overmolded by the polymeric carrier 12. In addition, during manufacture of the carrier 12, the connection element 3, more precisely a front side 13 of the base element 8, is back-injected by the polymeric material of the carrier 12, as a result of which a connection, for example a material-to-material connection, is produced between the carrier 12 and the connection element 3. In the manufacture of the carrier 12, the polymeric material of the carrier 12 is also injected around a lateral edge of the connection element 3 in such a way that an L-shaped holding section 14, which holds the connection element (at least also) in a positive-locking manner, is formed from the polymeric material of the carrier 12. In a region marked with the reference numeral 15, the polymeric material of the carrier 12 also penetrates into the connection element 3, specifically into the recess 10 formed between the base element 8 and the cover element 9, i.e., into the cavity. In this case, the section of the conductor 4 which runs through the cavity is encased by the polymeric material of the carrier 12. After the carrier 12 is manufactured, the connection element 3 is arranged on a rear side 16 of the carrier 12, which is opposite a visible side of the vehicle interior trim part 1 and is thus remote from a vehicle interior when the vehicle interior trim part 1 is installed in a vehicle.

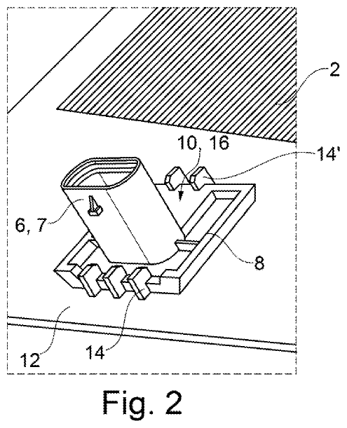

FIG. 2 shows a perspective view which is intended to illustrate the structure of the vehicle interior trim part 1 and, in particular, the filling of the recess 10. Recurring features are provided with the same reference numerals in this figure and in the following figures. The heating mat 2 and the carrier 12 are shown in partial views. The base element 8 has a recessed region which forms the recess 10 or a part thereof.

The conductors 4 run through the recess 10, wherein the cables 5 and connector pins 11 are soldered to one another within the recess 10. The cover element 9 with plug receptacle 6 is partially accommodated within the recessed region of the base element 8. During manufacture, the recess 10 is filled with polymeric material of the carrier 12, so that the conductors 4 are embedded into the polymeric material of the carrier 12 with in this region. As a rule, the holding sections, two of which are denoted by the reference numerals 14 and 14, are formed simultaneously with the filling of the recess 10 by the polymeric material of the carrier 12, namely in the injection molding step for manufacturing the carrier 12.

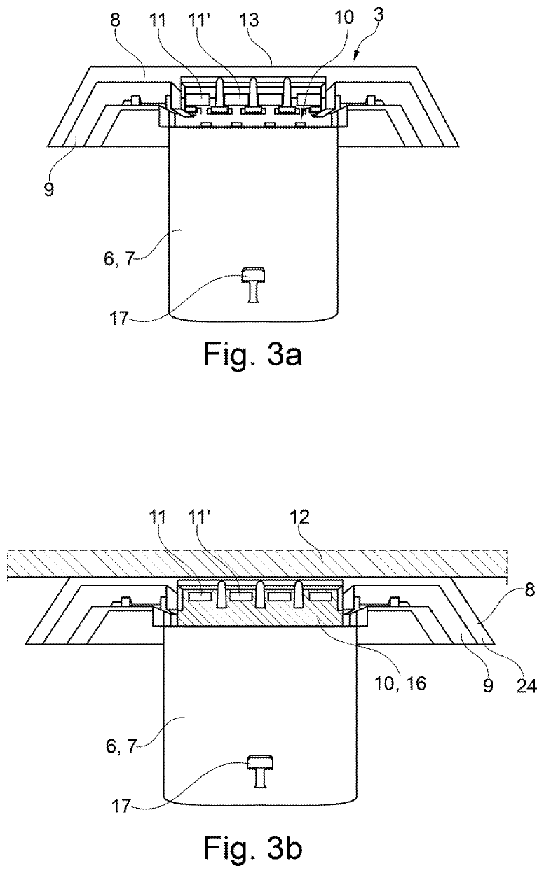

FIGS. 3(a) and 3(b) illustrate in partial sectional views the filling of the recess 10 with the polymeric material of the carrier 12. In an upper section of FIG. 3 (a), a sectional view of the connection element 3 is shown, while the guide element 7 of the plug receptacle 6, which projects rearward from the cover element 8 (downward in the illustration), is shown in a side view. The plug receptacle 6 also has a latching element 17 for securing a connection to the plug. The recess 10 in the form of the cavity is formed between the base element 8 and the cover element 9. Four connector pins, two of which are denoted by the reference numerals 11 and 11, are arranged in the recess 10. FIG. 3(b) shows a view after the manufacture of the carrier 12. In this case, the carrier 12 is integrally molded onto the front side 13 of the base element 8. In addition, the polymeric material of the carrier 12 has penetrated into the recess 10 of the connection element 3 and surrounds the connector pins 11, 11′. It can also be seen in FIGS. 3(a) and 3(b) that the cover element 9 is inserted in a fitting manner into the base element 8, so that outer surfaces of the cover element 9 rest against inner surfaces of an edge 24 of the base element 8. The base element 8 and the cover element 9 are each shell-shaped.

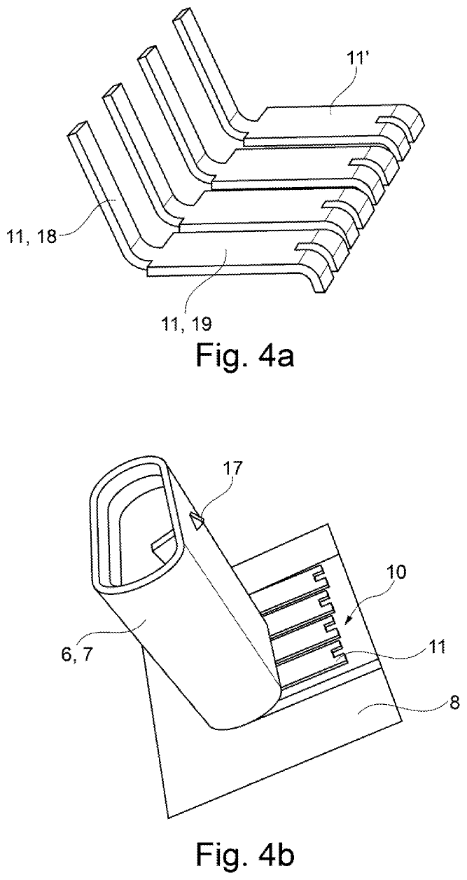

FIGS. 4(a) and (b) illustrate the four connector pins, of which two are again denoted by the reference numerals 11 and 11, and their arrangement in the connection element 3. The connector pins 11, 11′ run parallel to one another and each have an upwardly projecting section 18 and a section 19 running parallel to the carrier 12. The upwardly projecting section 18 of the connector pin is arranged in the guide element 7 of the plug receptacle 6 and serves for electrical connection to the plug. The section 19 of the connector pin running parallel to the carrier 12 runs into the recess 10 and is connected there, in particular soldered, to the associated cable 5 in order to produce the electrical connection to the device 2. The sections 19 of the connector pins 11 running parallel to the carrier 12 are shown in FIG. 4(b) for illustration purposes, even though in the viewing direction these sections are located on the rear side of the cover element.

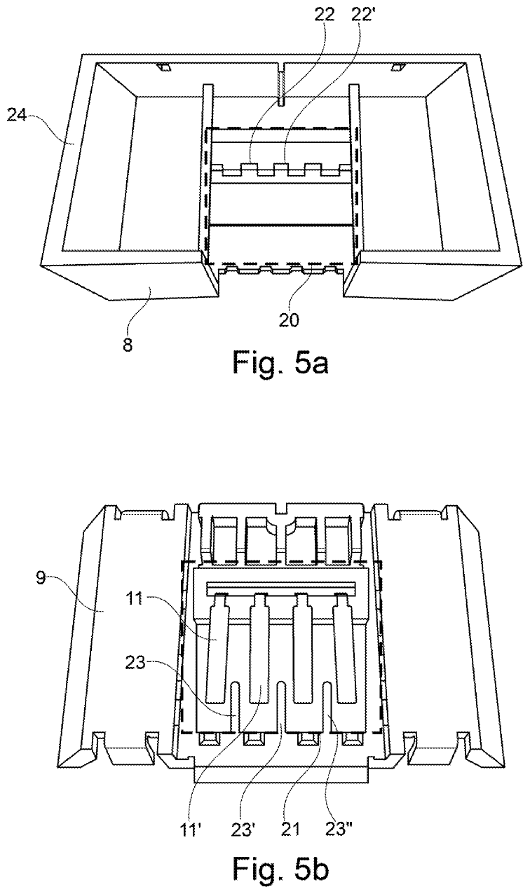

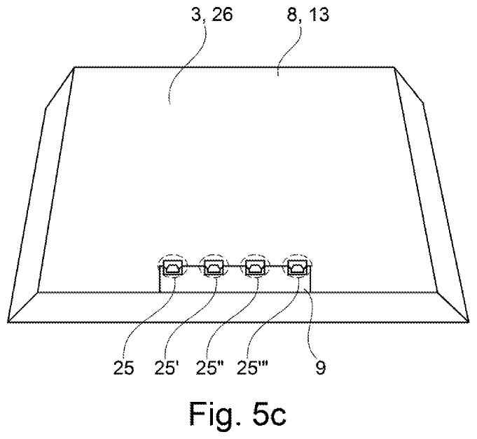

FIGS. 5(a) to (c) show further details of the connection element 3. FIG. 5(a) illustrates a rear side of the base element 8 into which the cover element 9, shown in FIG. 5 (b), is inserted. The base element 8 has a recessed region which is denoted by a dashed line 20. The region 20 forms, together with the region of the cover element 9, which is denoted by the reference numeral 21 in FIG. 5 (b), the recess or cavity 10 which is filled with the polymeric material of the carrier 12 when the carrier 12 is manufactured. The four connector pins 11, 11′ are arranged in the cavity delimited partially by the base element 8 and partially by the cover element 9. The base element 8 has support elements, two of which are denoted by way of example with the reference numerals 22 and 22; and which laterally support the connector pins 11, 11′ in the cavity 10. Moreover, the cover element 9 has ribs 23, 23; 23″ arranged between the connector pins 11, 11′ and extending parallel to these ribs within the cavity 10, which guide a flow of the polymeric material of the carrier 12 into the cavity 10 and which are surrounded on both sides by the polymeric material of the carrier 12. Four cables 5, which are soldered within the recess 10 with an associated one of the connector pins 11, 11, are each guided through one of four associated openings 25, 25; 25″, 25′ on a front side 26 or on a front edge of the connection element 3 into an interior of the connection element 3, more precisely into the recess 10. The openings 25, 25; 25″, 25′ are each partially delimited by the base element 8 and partially by the cover element 9, as illustrated in FIG. 5 (c). The polymeric material of the carrier 12 reaches the recess 10 through the openings 25, 25; 25″, 25′, in particular through a space between the cables 5 and an edge of the openings 25, 25; 25″, 25″.

Only features of the various embodiments disclosed in the exemplary embodiments can be combined with one another and claimed individually.

1. A vehicle interior trim part comprising:
a carrier having a polymeric material,
an electrical or optical device,
a connection element arranged on a rear side of the carrier for connecting the electrical or optical device,
at least one conductor that connects the electrical or optical device to the connection element,
wherein the connection element has a plug receptacle which is configured to produce an electrically or optically conductive connection of a plug to the at least one conductor,
wherein the connection element has a recess within which the at least one conductor is accommodated,
wherein the recess is at least partially filled by the polymeric material of the carrier such that the at least one conductor is surrounded by the polymeric material of the carrier at least in regions.

2. The vehicle interior trim part according to claim 1, characterized in that the connection element has a base element with a front side and a rear side, wherein the front side of the base element rests against the rear side of the carrier and the rear side of the base element delimits the recess.

3. The vehicle interior trim part according to claim 2, characterized in that the connection element has a cover element which is arranged on the base element and delimits the recess together with the base element.

4. The vehicle interior trim part according to claim 3, characterized in that the base element is at least partially shell-shaped, wherein the cover element is inserted into the base element.

5. The vehicle interior trim part according to claim 1, characterized in that the electrical or optical device is an electrical heating element.

6. The vehicle interior trim part according to claim 1, characterized in that the at least one conductor comprises at least one cable which electrically conductively connects the connection element to the electrical or optical device, and at least one connector pin which is accommodated within the connection element, wherein the at least one connector pin and the at least one cable are connected to one another within the recess of the connection element via a connection point.

7. The vehicle interior trim part according to claim 1, characterized in that the connection element has an opening which connects the recess to the carrier.

8. The vehicle interior trim part according to claim 7, characterized in that the at least one conductor runs through the opening.

9. The vehicle interior trim part according to claim 1, characterized in that the connection element has at least one rib for conducting a flow of the polymeric material of the carrier into the recess and/or within the recess.

10. The vehicle interior trim part according to claim 4, wherein outer surfaces of the cover element rest against inner surfaces of an edge of the base element.

11. The vehicle interior trim part according to claim 6, wherein the at least one connector pin includes four connector pins.

12. The vehicle interior trim part according to claim 6, wherein the at least one connector pin includes an upwardly projecting section and a section running parallel to the carrier.

13. The vehicle interior trim part according to claim 12, wherein the upwardly projecting second is located in a guide element of the plug receptable.

14. The vehicle interior trim part according to claim 1, further comprising at least one L-shaped holding section configured to hold the connection element.

15. The vehicle interior trim part according to claim 14, wherein the at least one L-shape holding section is formed from the polymeric material of the carrier.

16. A vehicle interior trim part comprising:
a carrier having a polymeric material,
a heating mat,
a connection element arranged on a rear side of the carrier for connecting the heating mat,
at least one conductor that connects the heating mat to the connection element,
wherein the connection element has a recess within which the at least one conductor is accommodated, and
wherein the recess is at least partially filled by the polymeric material of the carrier such that the at least one conductor is surrounded by the polymeric material of the carrier at least in regions.

17. The vehicle interior trim part according to claim 16, characterized in that the connection element has a base element with a front side and a rear side, wherein the front side of the base element rests against a rear side of the carrier and the rear side of the base element delimits the recess.

18. The vehicle interior trim part according to claim 17, characterized in that the connection element has a cover element which is arranged on the base element and delimits the recess together with the base element.

19. The vehicle interior trim part according to claim 18, characterized in that the base element is at least partially shell-shaped, wherein the cover element is inserted into the base element.

20. A method for manufacturing a vehicle interior trim part, comprising the following steps:
providing an electrical or optical device;
providing a conductor;
providing a connection element for connecting the electrical or optical device, wherein the connection element has a plug receptacle which is configured to produce an electrically or optically conductive connection of a plug to the conductor, wherein the conductor connects the electrical or optical device to the connection element and the connection elements have a recess within which the conductor is accommodated; and
manufacturing a carrier by injection molding with a polymeric material such that the connection element is arranged on a rear side of the carrier and the recess is at least partially filled by the polymeric material of the carrier in such a way that the conductor is at least partially surrounded by the polymeric material of the carrier.
